(19) United States
(12) Patent Application Publication
(10) Pub. No.: US 2026/0124934 A1
(43) Pub. Date: May 7, 2026

(54) STRUCTURAL BATTERY FOR VEHICLE

(71) Applicants: Hyundai Motor Company, Seoul (KR); Kia Corporation, Seoul (KR)

(72) Inventor: Won Ki Song, Hwaseong-si (KR)

(21) Appl. No.: 19/237,322

(22) Filed: Jun. 13, 2025

(30) Foreign Application Priority Data
Nov. 7, 2024 (KR) 10-2024-0157020

(51) Int. Cl. B60L 50/64; H01M 4/02; H01M 4/66; H01M 50/586; H01M 50/593

(52) U.S. Cl. CPC B60L 50/64; H01M 4/663; H01M 50/586; H01M 50/593; H01M 2004/027; H01M 2004/028

(57) ABSTRACT

A structural battery for a vehicle can include a plurality of positive electrode layers, a plurality of electrolyte layers, and a plurality of negative electrode layers that are sequentially laminated from top to bottom, wherein the positive electrode layers and the negative electrode layers each include a positive electrode and a negative electrode, respectively, in which a slurry layer is applied to both surfaces of a carbon fiber current collector layer thereof, and the carbon fiber current collector layer has a region that extends further outward than the slurry layer.

### CROSS-REFERENCE TO RELATED APPLICATIONS

This application claims priority to and the benefit of Korean Patent Application No. 10-2024-0157020 filed with the Korean Intellectual Property Office on Nov. 7, 2024, the entire contents of which are incorporated herein by reference.

### TECHNICAL FIELD

The present disclosure relates to a structural battery for a vehicle.

### BACKGROUND

Generally, a lithium-ion battery mounted on an electric vehicle occupies a significant portion of the weight of the electric vehicle, but does not perform any load-bearing function at all.

In contrast, as illustrated in FIG. 1, a structural battery 500 is a part that is installed in a frame or structure 800 constituting an electric vehicle 1000 and simultaneously performs own load-bearing and charging/discharging and boosting functions of a high-voltage battery 600 installed on a floor 700 of the vehicle body. In other words, the structural battery 500 may function as a battery while performing the function of an electric vehicle structure.

This battery is also called a massless energy storage device, which is because, when the weight of the battery becomes a portion of the load-bearing structure, the weight of the battery storing energy is virtually nonexistent. These composite function batteries may significantly reduce the weight of the vehicle. When the structural battery is applied to electric vehicles, the weight is reduced and a driving range may be improved.

In addition, the structural battery has a capacity of about 20% of the capacity of a lithium-ion battery, which is lower than that of the lithium-ion battery, but the weight is significantly reduced because there is no separate battery, and as a result, the energy required to drive the electric vehicle is reduced. Furthermore, the structural battery has a lower electric energy density and higher stability.

However, as shown in FIG. 2, the general pouch-type battery of the related art has a structure in which a positive electrode 10 including a positive electrode slurry 12 and an aluminum current collector 14 and a negative electrode 20 including a negative electrode slurry 22 and an aluminum current collector 24 are laminated with a separator 30 therebetween and pouch films 40 are attached to the outermost portions. This structure has problems in that the mechanical rigidity and durability are weak because the separator 30 is used for insulation between the current collectors 14 and 24. Therefore, a structure that improves the rigidity function by applying a solid electrolyte layer instead of a separator has been developed recently. In addition, a structural battery that may improve the mechanical rigidity and insulation function by laminating a glass fiber prepreg insulator on an outer portion of the battery and forming a sealing region impregnated with a resin has been developed.

Therefore, continuous research and development on structural batteries applied to vehicles is necessary.

### SUMMARY

The present disclosure relates to a structural battery for vehicles, and more particularly, to a structural battery for electric vehicles that may be applied as a member of a vehicle body to mechanically connect parts, while being electrochemically connected with a lithium-ion battery to boost voltage.

An embodiment of the present disclosure can provide a structural battery for an electric vehicle, in which a carbon fiber current collector with a region expanded beyond an electrolyte can be provided in the structural battery having a series connection structure, a resin-impregnated region can be formed outside the expanded current collector to have an integrated structure between electrodes, and an expanded and reinforced structure can be realized through intralayer/interlayer bonding of electrodes.

According to an example embodiment of the present disclosure, a structural battery for an electric vehicle can include a plurality of positive electrode layers, a plurality of electrolyte layers, and a plurality of negative electrode layers that can be sequentially laminated from top to bottom, wherein the positive electrode layer and the negative electrode layer of each, respectively, can include a positive electrode and a negative electrode in which a slurry layer is applied to both surfaces of a carbon fiber current collector layer, and the carbon fiber current collector layer can have a region that extends further outward than the slurry layer.

Edge portions of the positive electrode layer, the electrolyte layer, and the negative electrode layer may be impregnated with a resin and sealed.

At the edges of the positive electrode layers and negative electrode layers, each can have a glass fiber insulating layer having a region extending further outward than the carbon fiber current collector layer may be provided.

An inner portion of the glass fiber insulating layer may be attached to an edge portion of the carbon fiber current collector layer by a resin material.

The positive electrode may be formed by applying a positive electrode slurry layer to both surfaces of the respective carbon fiber current collector layer, and the negative electrode may be formed by applying a negative electrode slurry layer to both surfaces of the respective carbon fiber current collector layer.

The positive electrode slurry layer may include a positive electrode active material, a binder, and a conductive agent, and the negative electrode slurry layer may include a negative electrode active material, a binder, and a conductive agent.

A carbon fiber structure reinforcement layer may be laminated in an outer portion of each of outermost upper and lower layers.

A pouch film may be laminated between the outermost upper and lower layers and the respective adjacent carbon fiber structure reinforcement layer.

The positive electrode layers and negative electrode layers may each be provided in plurality on a same plane.

A plurality of glass fiber insulating layers of the positive electrode layers and a plurality of glass fiber insulating layers of the negative electrode layers may respectively be arranged face to face and connected in the same plane.

A connection portion of the plurality of glass fiber insulating layers of the positive electrode layers and a connection portion of the plurality of glass fiber insulating layers of the negative electrode layers may be formed to be misaligned with respect to a vertical direction.

The positive electrode layers and negative electrode layers may be provided in plurality on different planes.

The plurality of glass fiber insulating layers of the positive electrode layers and the plurality of glass fiber insulating layers of the negative electrode layers may be arranged to overlap each other.

The plurality of glass fiber insulating layers of the positive electrode layers and the plurality of glass fiber insulating layers of the negative electrode layers may be pressed and heat-fused to be coupled to a glass fiber insulating layer on another plane in a joggle shape (e.g., step or offset bend shaped).

The positive electrode layers and negative electrode layers may be arranged alternately above and below each other and coupled.

According to an embodiment of the present disclosure, a structural battery can include a series connection structure, a structure having a current collector extended beyond the electrolyte region can be provided, and a resin-impregnated region can be formed outside the expanded current collector, thereby preventing moisture from flowing in and out between the electrolyte inside the current collector and the outside and reducing electrochemical resistance and increasing electrical efficiency.

Using an embodiment of the present disclosure, through intralayer/interlayer bonding of the structural battery electrode, intralayer/interlayer rigidity may be improved in all expanded cell regions.

By installing the structural battery functioning as a battery in the frame structure of the vehicle, according to an embodiment of the present disclosure, battery space may be saved, the layout may be improved, the weight may be reduced, the fuel efficiency may be improved, and the marketability of the vehicle may be improved.

### BRIEF DESCRIPTION OF THE DRAWINGS

FIG. 1 is a schematic diagram of an electric vehicle to which a structural battery for an electric vehicle according to an example embodiment of the present disclosure can be applied.

FIG. 2 is a diagram schematically illustrating a laminated structure of a general pouch film cell used as an existing structural battery for an electric vehicle.

FIG. 3 is a diagram illustrating a laminated structure of a negative electrode of a structural battery for an electric vehicle according to an example embodiment of the present disclosure.

FIG. 4 is an exploded-view diagram illustrating a state in which a negative electrode and a glass fiber insulating layer of a structural battery for an electric vehicle can be coupled according to an example embodiment of the present disclosure.

FIG. 5 is a cross-sectional view illustrating a state in which a negative electrode and a glass fiber insulating layer of a structural battery for an electric vehicle can be coupled according to an example embodiment of the present disclosure.

FIG. 6 is an exploded-view diagram illustrating a state in which a negative electrode layer and a positive electrode layer of a structural battery for an electric vehicle can be coupled according to an example embodiment of the present disclosure.

FIG. 7 is a cross-sectional view illustrating a laminated structure between a negative electrode layer and a positive electrode layer of a structural battery for an electric vehicle according to an example embodiment of the present disclosure.

FIG. 8 is an exploded-view drawing illustrating a structure in which a negative electrode layer and a positive electrode layer of a structural battery for an electric vehicle can be coupled according to an example embodiment of the present disclosure.

FIG. 9 is a cross-sectional view illustrating a laminated structure between a negative electrode layer and a positive electrode layer of a structural battery for an electric vehicle according to an example embodiment of the present disclosure.

FIG. 10 is an exploded-view drawing illustrating state in which a negative electrode layer and a positive electrode layer can be arranged face-to-face in a same layer and overlap in upper and lower layers of a structural battery for an electric vehicle according to an example embodiment of the present disclosure.

FIG. 11 is a cross-sectional view illustrating a state in which a negative electrode layer and a positive electrode layer overlap in upper and lower layers of a structural battery for an electric vehicle according to an example embodiment of the present disclosure.

FIG. 12 is an exploded-view sequential drawing illustrating states in which a negative electrode layer and a positive electrode layer can be arranged to overlap in a same layer and in upper and lower layers of a structural battery for an electric vehicle according to an example embodiment of the present disclosure.

FIG. 13 is a cross-sectional view sequentially illustrating states in which a negative electrode layer and a positive electrode layer of a structural battery for an electric vehicle can be arranged to overlap in the same layer and in upper and lower layers and formed in a joggle shape by pressing and heat fusion according to an example embodiment of the present disclosure.

FIG. 14 is an exploded-view sequential drawing illustrating states in which a negative electrode layer and a positive electrode layer of a structural battery for an electric vehicle can be vertically alternately arranged and laminated to be coupled according to an example embodiment of the present disclosure.

### DETAILED DESCRIPTION OF ILLUSTRATIVE EMBODIMENTS

Hereinafter, reference will be now made to the example embodiments of the present disclosure with reference to the attached drawings in a manner sufficiently detailed, which can be readily carried out by a person skilled in the art to which the present disclosure pertains. As those skilled in the art can realize, the described example embodiments may be modified in various different ways, all without departing from the spirit or scopes of the present disclosure.

In various example embodiments, components having the same configuration are representatively described in an example embodiment using the same reference numerals, and in other example embodiments, only components that are different from the example embodiment are described.

It can be noted that the drawings are schematically illustrated but not necessarily scaled in proportion. Therefore, in the attached drawings, the relative dimensions and proportions of the components can be illustrated to be more enlarged or reduced than they actually are to clarify the present disclosure, and a certain size is just illustrative but not limited thereto. In the drawings, the same structures, elements or parts have the same reference numerals so as to denote similar features even though they are illustrated in different figures. When it is said that any portion is positioned “on” another part, it means the portion is directly on the other portion or above the other portion with at least one intermediate part.

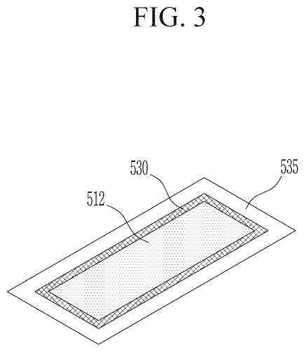

Example embodiments are shown in FIGS. 3 to 14. As a result, various modifications of the drawings can be anticipated. Therefore, the example embodiments are not limited to a specific form of an illustrated region, and for example, can include modifications of a manufactured form.

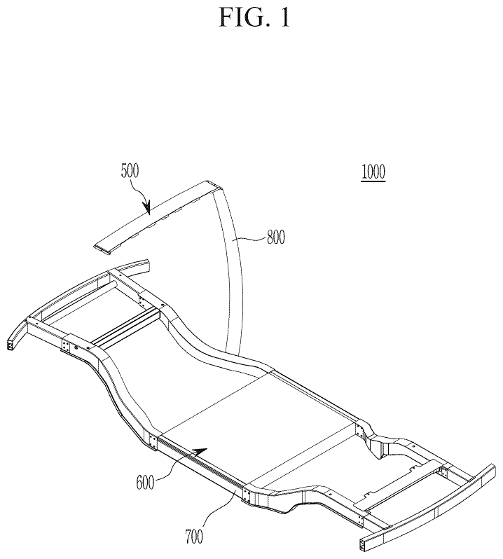

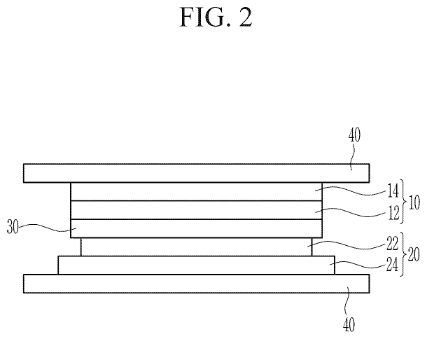

Next, a structural battery for an electric vehicle according to an example embodiment of the present disclosure will be described with reference to FIGS. 1 to 8.

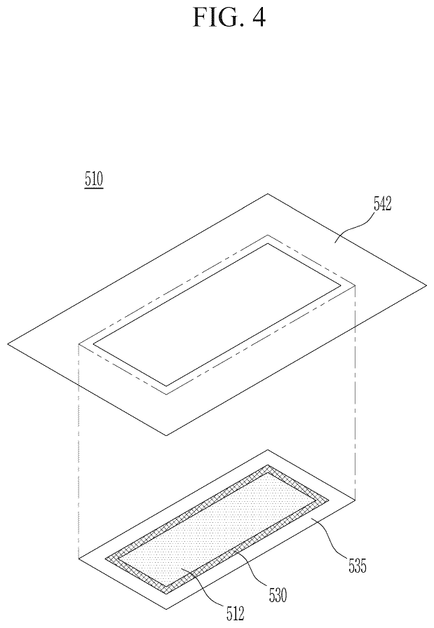

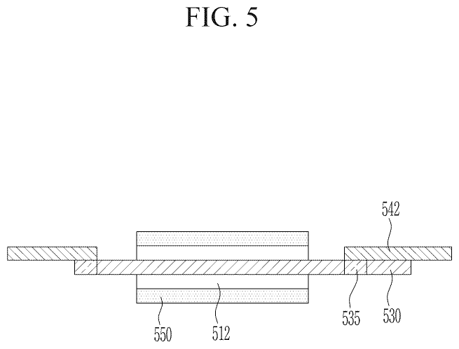

FIG. 3 is a diagram illustrating a laminated structure of a negative electrode of a structural battery for an electric vehicle according to an example embodiment of the present disclosure. FIG. 4 is an exploded-view diagram illustrating a state in which a negative electrode and a glass fiber insulating layer of the structural battery for an electric vehicle can be coupled according to an example embodiment of the present disclosure. FIG. 5 is a cross-sectional view illustrating a state in which a negative electrode and a glass fiber insulating layer of a structural battery for an electric vehicle are coupled according to an example embodiment of the present disclosure.

Referring to FIGS. 3 to 9, a structural battery for an electric vehicle according to an example embodiment of the present disclosure can be formed by sequentially laminating a plurality of positive electrode layers 510, a plurality of electrolyte layers 550, and a plurality of negative electrode layers 520 from top to bottom.

The positive electrode layer 510 and the negative electrode layer 520 can include a positive electrode and a negative electrode, respectively, on which slurry layers 512 and 522 are applied to both surfaces of a carbon fiber current collector layer 530. The positive electrode can be formed by applying the positive electrode slurry layer 512 to both surfaces of the carbon fiber current collector layer 530, and the negative electrode can be formed by applying the negative electrode slurry layer 522 to both surfaces of the carbon fiber current collector layer 530.

The positive electrode slurry layer 512 may include a positive electrode active material, a binder, and a conductive agent, and the negative electrode slurry layer 522 may include a negative electrode active material, a binder, and a conductive agent. The positive electrode slurry layer 512 and the negative electrode slurry layer 522 may additionally include a conductive agent to supplement the conductivity of the positive electrode active material and the negative electrode active material, and the conductivity of the electrode active material may be improved by bonding each electrode active material and the conductive agent with a binder.

The positive electrode may include the positive electrode slurry layer 512 and the positive electrode carbon fiber current collector layer 530, and the negative electrode may include a negative electrode slurry layer 522 and a negative electrode carbon fiber current collector layer 530. The positive electrode and the negative electrode each constitute the positive electrode layer 510 and the negative electrode layer 520, respectively, and the positive electrode layer 510 and the negative electrode layer 520 may be connected by the electrolyte layer 550 therebetween.

The electrolyte layer 550 may allow lithium ions to pass therethrough and block electrons, thereby implementing a redox reaction between the positive electrode and the negative electrode, and may include a solid electrolyte.

A glass fiber insulator layer (e.g., “prepreg”) 542 may be provided at the edge of each positive electrode layer 510 and each negative electrode layer 520. The prepreg may include a non-conductive glass fiber impregnated with a resin and insulate carbon fiber current collector layers 530. The glass fiber insulating layer 542 may have a square or rectangular opening formed in the center so as to be attached to four edge portions of the carbon fiber current collector 530. In a cross-section, the glass fiber insulating layer 542 and the slurry layer 512 are spaced apart from each other by a certain distance, and the slurry layer 512 and the carbon fiber current collector layer 530 are exposed through the opening of the glass fiber insulating layer 542.

The carbon fiber current collector layer 530 may have a region that extends further toward an outer side than the positive electrode slurry layer 512 and the negative electrode slurry layer 522. The edge portions of the positive electrode layer 510, the electrolyte layer 550, and the negative electrode layer 520 may be impregnated with a resin and sealed.

Although not shown, the positive electrode tab and the negative electrode tab may be positioned to extend from the inside to the outside of the sealed region. That is, a connection portion of the positive electrode tab and the negative electrode tab with the carbon fiber collector layer 530 can be located inside the conductive sealing region. The resin-impregnated region can be a region in which electricity does not flow, mechanical strength is improved, and moisture, etc. does not penetrate from the outside.

At the edges of the positive electrode layer 510 and the negative electrode layer 520, the glass fiber insulator layer 542 having a region that expands further outward than the carbon fiber collector layer 530 can be provided. An inner lower portion of the glass fiber insulator layer 542 may be attached to an upper portion of the edge of the carbon fiber collector layer 530 by resin material 535.

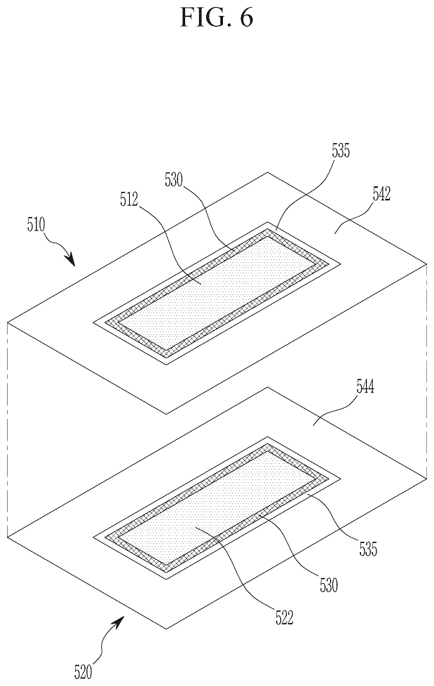

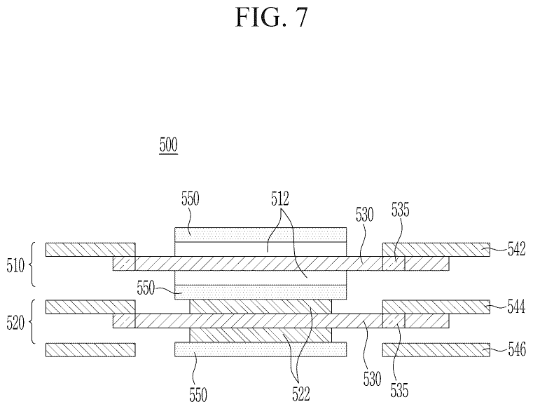

FIG. 6 is an exploded-view diagram illustrating a state in which a negative electrode layer and a positive electrode layer of a structural battery for an electric vehicle can be coupled according to an example embodiment of the present disclosure. FIG. 7 is a cross-sectional view illustrating a laminated structure including a negative electrode layer and a positive electrode layer of a structural battery for an electric vehicle according to an example embodiment of the present disclosure.

As shown in FIGS. 6 and 7, the positive electrode layer 510 and the negative electrode layer 520 may be laminated in a vertical direction. In some embodiments, a plurality of positive electrode layers 510 and a plurality of negative electrode layers 520 may be alternately and sequentially laminated. The electrolyte layer 550 can be laminated between the plurality of positive electrode layers 510 and the plurality of negative electrode layers 520, allowing lithium ions to pass between the positive electrode layer 510 and the negative electrode layer 520 and blocking electrons to implement a redox reaction between the positive electrode and the negative electrode.

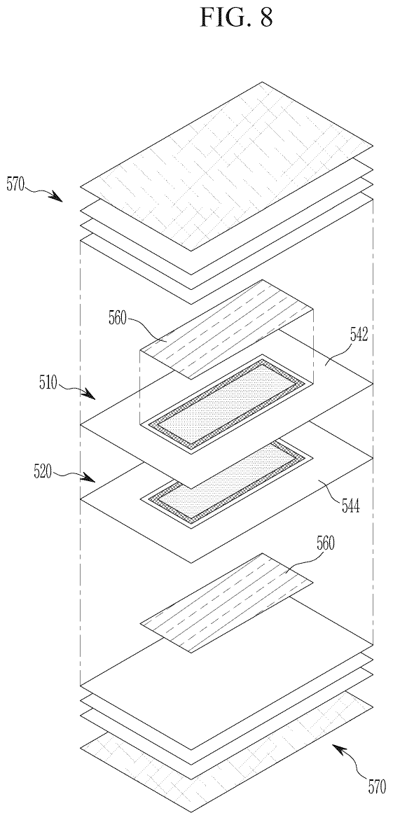

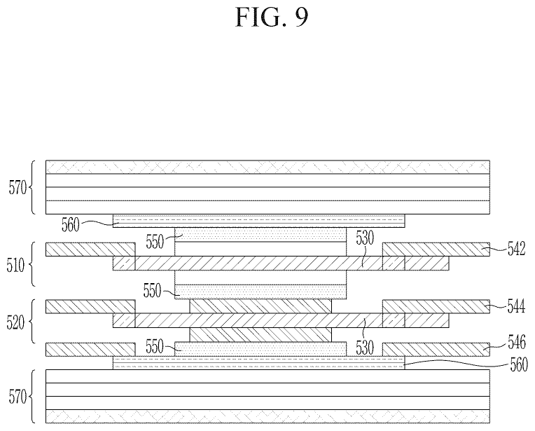

FIG. 8 is an exploded-view drawing illustrating a structure in which a negative electrode layer and a positive electrode layer of a structural battery for an electric vehicle can be coupled according to an example embodiment of the present disclosure. FIG. 9 is a cross-sectional view illustrating a laminated structure between a negative electrode layer and a positive electrode layer of a structural battery for an electric vehicle according to an example embodiment of the present disclosure.

Referring to FIGS. 8 and 9, in a structure of the structural battery for an electric vehicle according to an example embodiment of the present disclosure, carbon fiber structure reinforcement layers 570 may be laminated on the outer portions of the respective upper and lower outermost electrolyte layers 550. Although FIGS. 8 and 9 show only one positive electrode layer 510 and one negative electrode layer 520, in some embodiments, there can be a plurality of positive electrode layers 510 and a plurality of negative electrode layers 520 alternately laminated between the carbon fiber structure reinforcement layers 570, for example. The carbon fiber structure reinforcement layer 570 may include a plurality of layers, and a pouch film 560 may be laminated between the upper and lower outermost electrolyte layers 550 and the carbon fiber structure reinforcement layer 570.

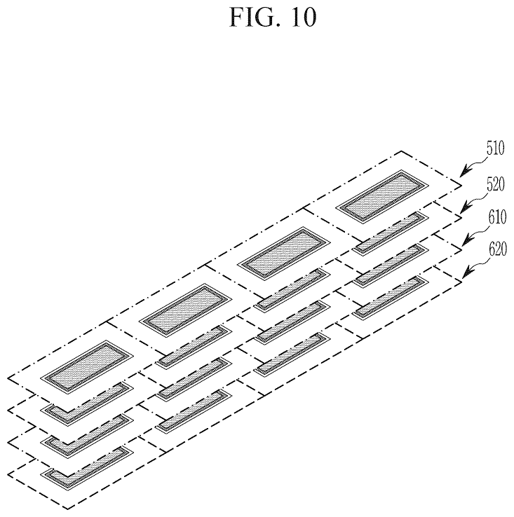

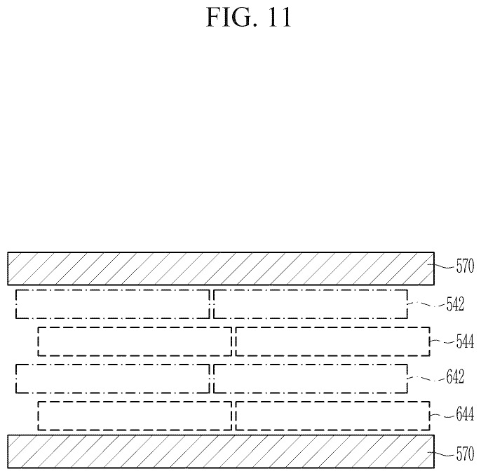

FIG. 10 is an exploded-view drawing illustrating a state in which a negative electrode layer and a positive electrode layer are arranged face-to-face in the same layer and overlap in upper and lower layers of a structural battery for an electric vehicle according to an example embodiment of the present disclosure. FIG. 11 is a cross-sectional view illustrating a state in which a negative electrode layer and a positive electrode layer are arranged face-to-face in the same layer and overlap in upper and lower layers of a structural battery for an electric vehicle according to an example embodiment of the present disclosure.

Referring to FIG. 10, the positive electrode layers 510 and 610 and the negative electrode layers 520 and 620 may be provided in plurality on the same plane. The plurality of positive electrode layers 510 and 610 provided on the same plane may be arranged in a row and connected. The plurality of negative electrode layers 520 and 620 may be arranged in a row on the same plane and connected below the plurality of positive electrode layers 510 and 610. From top to bottom, the plurality of positive electrode layers 510 and 610 and the plurality of negative electrode layers 520 and 620 may be alternately laminated.

A plurality of glass fiber insulating layers 542 and 642 of the positive electrode layers 510 and 610 may be arranged face-to-face and connected on the same plane, and similarly, a plurality of glass fiber insulating layers 544 and 644 of the negative electrode layers 520 and 620 may be arranged face-to-face and connected on the same plane.

As illustrated in FIG. 11, a connection portion of the plurality of glass fiber insulating layers 542 and 642 of the positive electrode layers 510 and 610 and a connection portion of the plurality of glass fiber insulating layers 544 and 644 of the negative electrode layers 520 and 620 may be formed to be misaligned with respect to each other in the vertical direction. The face-to-face disconnected portions of the adjacent electrode layers may overlap, so that the connectivity of the disconnected portions may be secured.

During heat fusion, a residual resin of the glass fiber prepreg layer may flow into the electrode layers and the disconnected portions between the electrode layers and is cured, so that all layers within the electrode layers and between the electrode layers may be combined and integrated, thereby improving rigidity in all expanded cell regions.

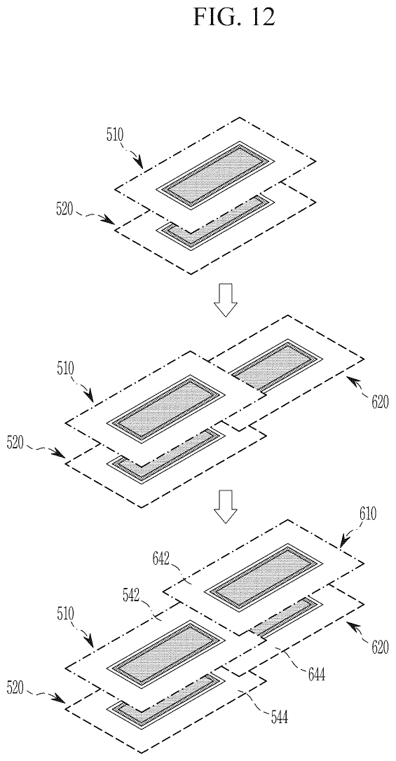

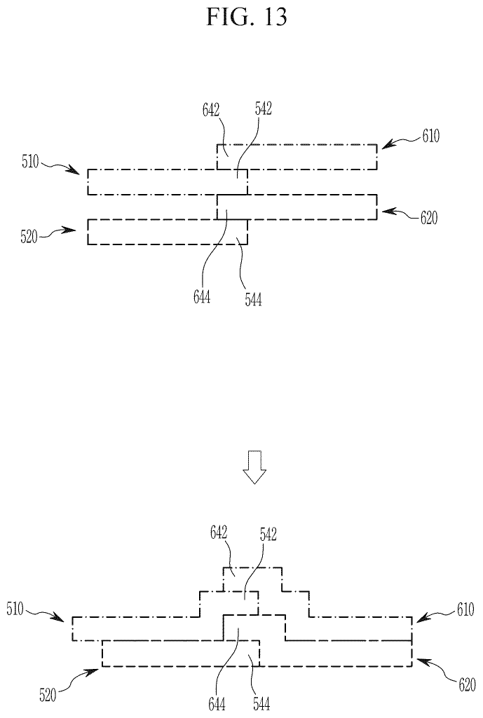

FIG. 12 is an exploded-view sequential drawing illustrating a configuration of negative electrode layers and positive electrode layers arranged to overlap in a same layer and in upper and lower layers of a structural battery for an electric vehicle according to an example embodiment of the present disclosure. FIG. 13 is a cross-sectional view sequentially illustrating states in which negative electrode layers and positive electrode layers of a structural battery for an electric vehicle are arranged to overlap in a same layer and in upper and lower layers and formed in a joggle shape by pressing and heat fusion according to an example embodiment of the present disclosure.

Referring to FIG. 12, the positive electrode layers 510 and 610 and the negative electrode layers 520 and 620 may be provided in plurality on different planes, respectively. The positive electrode layers 510 and 610 and the negative electrode layers 520 and 620 may be individually positioned on each plane. The positive electrode layer 510 and the negative electrode layer 520 may be arranged at the same position in the vertical direction, another negative electrode layer 620 may be disposed between the positive electrode layer 510 and the negative electrode layer 520, and another positive electrode layer 610 may be disposed on top of the positive electrode layer 510. That is, the plurality of glass fiber insulating layers 542 and 642 of the positive electrode layers 510 and 610 and the plurality of glass fiber insulating layers 544 and 644 of the negative electrode layers 520 and 620 may be arranged to overlap each other, respectively.

Referring to FIG. 13, a plurality of glass fiber insulating layers 542 and 642 of the positive electrode layers 510 and 610 and a plurality of glass fiber insulating layers 544 and 644 of the negative electrode layers 520 and 620 may be pressed and heat-fused to be coupled to glass fiber insulating layers on another plane in a joggle shape. When forming the joggle shape, electrode layers of the same polarity may be arranged on the same layer, and the bonding rigidity between cells may be improved by the joggle shape.

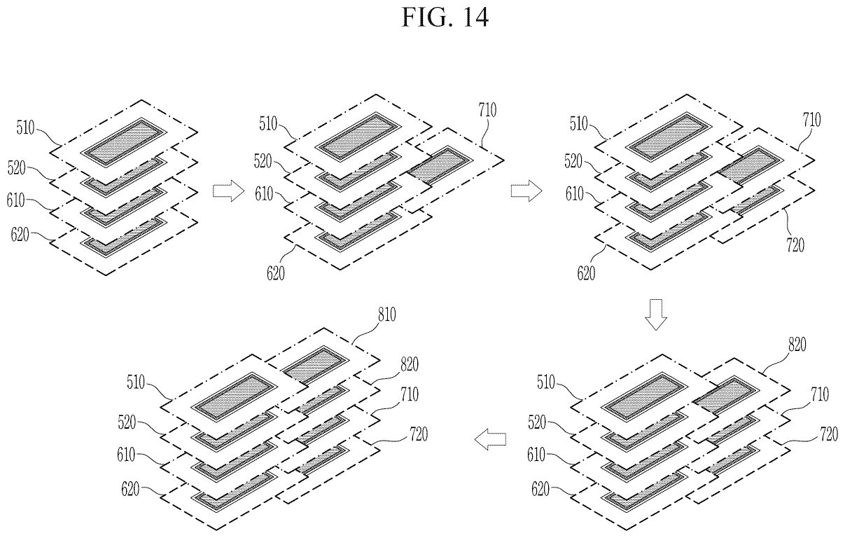

FIG. 14 is an exploded-view sequential drawing illustrating states in which a negative electrode layer and a positive electrode layer of a structural battery for an electric vehicle can be alternately arranged and laminated to be coupled according to an example embodiment of the present disclosure.

Referring to FIG. 14, the electrode layer of the structural battery for an electric vehicle may be formed to extend to more electrode layers in the laminated shape of the electrode layers illustrated in FIGS. 12 and 13. The positive electrode layers 510, 610, 710, and 810 and the negative electrode layers 520, 620, 720, and 820 may be provided in plurality on different planes and may be arranged at the same position in the vertical direction, and the plurality of glass fiber insulating layers of the positive electrode layers 510, 610, 710, and 810 and the plurality of glass fiber insulating layers of the negative electrode layers 520, 620, 720, and 820 may be arranged to overlap each other.

Also, in this example, the plurality of glass fiber insulating layers of the positive electrode layers 510, 610, 710, and 810 and the plurality of glass fiber insulating layers of the negative electrode layers 520, 620, 720, and 820 may be pressed and heat-fused to be coupled to the glass fiber insulating layers on other planes in a joggle shape, and the bonding rigidity between cells may be improved by the joggle shape.

As described above, according to an embodiment of the present disclosure, in the structural battery having a series connection structure, a structure having a current collector extended beyond the electrolyte region can be provided and a resin-impregnated region can be formed outside the expanded current collector, thereby preventing moisture from flowing in and out between the electrolyte inside the current collector and the outside thereof, and reducing electrochemical resistance and increasing electrical efficiency.

In an embodiment of the present disclosure, through intralayer/interlayer bonding of the structural battery electrode, intralayer/interlayer rigidity may be improved in all expanded cell regions.

Using an embodiment of the present disclosure, by installing the structural battery functioning as a battery in the frame structure of the vehicle, battery space may be saved, the layout may be improved, the weight may be reduced, the fuel efficiency may be improved, and the marketability of the vehicle may be improved.

While the present disclosure has been described in connection with what is presently considered to be practical example embodiments, it can be understood that the present disclosure is not necessarily limited to the disclosed example embodiments. On the contrary, it is intended to cover various modifications and equivalent arrangements included within the spirit and scopes of the appended claims.

What is claimed is:

1. A structural battery for a vehicle, comprising:
a plurality of positive electrode layers;
a plurality of electrolyte layers; and
a plurality of negative electrode layers,
wherein the plurality of positive electrode layers, the plurality of electrolyte layers, and the plurality of negative electrode layers are sequentially laminated from top to bottom,
wherein each of
the plurality of positive electrode layers and each of the plurality of negative electrode layers includes a positive electrode and a negative electrode, respectively, in which a slurry layer is applied to both surfaces of a carbon fiber current collector layer thereof, and
wherein the carbon fiber current collector layer has a carbon-fiber-current-collector-layer region that extends further outward than the slurry layer.

2. The structural battery of claim 1, wherein edge portions of each of the plurality of positive electrode layers, each of the plurality of electrolyte layers, and each of the plurality of negative electrode layers are impregnated with a resin and sealed.

3. The structural battery of claim 1, wherein at edge portions of the plurality of positive electrode layers and the plurality of negative electrode layers, each of the plurality of positive electrode layers and each of the plurality of negative electrode layers comprises
a glass fiber insulating layer having a glass-fiber-insulating-layer region extending further outward than the carbon fiber current collector layer.

4. The structural battery of claim 3, wherein an inner portion of the glass fiber insulating layer is attached to a carbon-fiber-current-collector-layer edge portion of the carbon fiber current collector layer by resin material.

5. The structural battery of claim 1, wherein the positive electrode comprises a positive electrode slurry layer applied to the both surfaces of the respective carbon fiber current collector layer, and
wherein the negative electrode comprises a negative electrode slurry layer applied to the both surfaces of the respective carbon fiber current collector layer.

6. The structural battery of claim 5, wherein the positive electrode slurry layer comprises a positive electrode active material, a first binder, and a first conductive agent, and
wherein the negative electrode slurry layer comprises a negative electrode active material, a second binder, and a second conductive agent.

7. The structural battery of claim 1, further comprising a carbon fiber structure reinforcement layer laminated in an outer portion of each of outermost upper and lower layers.

8. The structural battery of claim 7, further comprising a pouch film laminated between the carbon fiber structure reinforcement layer and each of the outermost upper and lower layers, respectively.

9. The structural battery of claim 1, wherein the plurality of positive electrode layers and the plurality of negative electrode layers are on a same plane.

10. The structural battery of claim 9, wherein a first plurality of glass fiber insulating layers of the plurality of positive electrode layers and a second plurality of glass fiber insulating layers of the plurality of negative electrode layers are respectively arranged face to face and connected in the same plane.

11. The structural battery of claim 10, wherein a first connection portion of the first plurality of glass fiber insulating layers of the plurality of positive electrode layers and a second connection portion of the second plurality of glass fiber insulating layers of the plurality of negative electrode layers are disposed to be misaligned with respect to a vertical direction.

12. The structural battery of claim 1, wherein the plurality of positive electrode layers and the plurality of negative electrode layers are provided in plurality on different planes.

13. The structural battery of claim 12, wherein a first plurality of glass fiber insulating layers of the plurality of positive electrode layers and a second plurality of glass fiber insulating layers of the plurality of negative electrode layer are arranged to overlap each other.

14. The structural battery of claim 13, wherein the first plurality of glass fiber insulating layers of the plurality of positive electrode layers and the second plurality of glass fiber insulating layers of the plurality of negative electrode layer are pressed and heat-fused to be coupled in a joggle shape.

15. The structural battery of claim 13, wherein the plurality of positive electrode layers and the plurality of negative electrode layers are arranged alternately above and below each other and coupled.

16. A structural battery for a vehicle, comprising:
a positive electrode layer comprising a positive electrode, wherein the positive electrode comprises:
a positive carbon fiber current collector layer,
a first positive slurry layer on a first positive-carbon-fiber-current-collector-layer side of the positive carbon fiber current collector layer, and
a second positive slurry layer on a second positive-carbon-fiber-current-collector-layer side of the positive carbon fiber current collector layer, wherein the first positive-carbon-fiber-current-collector-layer side is opposite the second positive-carbon-fiber-current-collector-layer side, wherein the positive carbon fiber current collector layer includes an outer positive-carbon-fiber-current-collector-layer region extending further outward than the first positive slurry layer and the second positive slurry layer;
a negative electrode layer comprising a negative electrode, wherein the negative electrode comprises:
a negative carbon fiber current collector layer,
a first negative slurry layer on a first negative-carbon-fiber-current-collector-layer side of the negative carbon fiber current collector layer, and
a second negative slurry layer on a second negative-carbon-fiber-current-collector-layer side of the negative carbon fiber current collector layer, wherein the first negative-carbon-fiber-current-collector-layer side is opposite the second negative-carbon-fiber-current-collector-layer side, wherein the negative carbon fiber current collector layer includes an outer negative-carbon-fiber-current-collector-layer region extending further outward than the first negative slurry layer and the second negative slurry layer; and
an electrolyte layer between and in electrical contact with the second positive slurry layer and the first negative slurry layer.

17. The structural battery of claim 16, wherein the positive electrode layer further comprises a first glass fiber insulating layer framed about the positive electrode and attached to the outer positive-carbon-fiber-current-collector-layer region of the positive carbon fiber current collector layer, such that the first glass fiber insulating layer includes an outer first-glass-fiber-insulating-layer region extending further outward than the positive carbon fiber current collector layer, and
wherein the negative electrode layer further comprises a second glass fiber insulating layer framed about the negative electrode and attached to the outer negative-carbon-fiber-current-collector-layer region of the negative carbon fiber current collector layer, such that the second glass fiber insulating layer includes an outer second-glass-fiber-insulating-layer region extending further outward than the negative carbon fiber current collector layer.

18. The structural battery of claim 16, wherein each of the first positive slurry layer and the second positive slurry layer comprises a positive electrode active material, a first binder, and a first conductive agent, and
wherein each of the first negative slurry layer and the second negative slurry layer comprises a negative electrode active material, a second binder, and a second conductive agent.

19. A structural battery for a vehicle, comprising:
a plurality of positive electrode layers, wherein each of the plurality of positive electrode layers comprises a positive electrode, wherein the positive electrode comprises:
a positive carbon fiber current collector layer,
a first positive slurry layer on a first positive-carbon-fiber-current-collector-layer side of the positive carbon fiber current collector layer, and
a second positive slurry layer on a second positive-carbon-fiber-current-collector-layer side of the positive carbon fiber current collector layer, wherein the first positive-carbon-fiber-current-collector-layer side is opposite the second positive-carbon-fiber-current-collector-layer side, wherein the positive carbon fiber current collector layer includes an outer positive-carbon-fiber-current-collector-layer region extending further outward than the first positive slurry layer and the second positive slurry layer;
a plurality of negative electrode layers, wherein each of the plurality of negative electrode layers comprises a negative electrode, wherein the negative electrode comprises:
a negative carbon fiber current collector layer,
a first negative slurry layer on a first negative-carbon-fiber-current-collector-layer side of the negative carbon fiber current collector layer, and
a second negative slurry layer on a second negative-carbon-fiber-current-collector-layer side of the negative carbon fiber current collector layer, wherein the first negative-carbon-fiber-current-collector-layer side is opposite the second negative-carbon-fiber-current-collector-layer side, wherein the negative carbon fiber current collector layer includes an outer negative-carbon-fiber-current-collector-layer region extending further outward than the first negative slurry layer and the second negative slurry layer; and
a plurality of electrolyte layers sandwiching the plurality of positive electrode layers and sandwiching the plurality of negative electrode layers with an alternating vertical stack sequence for placements of the plurality of positive electrode layers and the plurality of negative electrode layers relative to the plurality of electrolyte layers, such that for a positive given one of the plurality of positive electrode layers, an electrolyte given one of the plurality of electrolyte layers, and a given negative one of the plurality of negative electrode layers stacked in a first vertical sequence set, the electrolyte given one of the plurality of electrolyte layers is between and in electrical contact with the second positive slurry layer of the positive given one of the plurality of positive electrode layers and the first negative slurry layer of the negative given one of the plurality of negative electrode layers.

20. The structural battery of claim 19, further comprising:
an upper pouch film laminated on an uppermost one of the plurality of electrolyte layers;
an upper carbon fiber structure reinforcement layer laminated on the upper pouch film;
a lower pouch film laminated on a lowermost one of the plurality of electrolyte layers; and
a lower carbon fiber structure reinforcement layer laminated on the lower pouch film.
